(19) United States
(12) Patent Application Publication
(10) Pub. No.: US 2003/0007543 A1
(43) Pub. Date: Jan. 9, 2003

(54) Use of fluorinated ketones as test fluids in the testing of electronic components

(75) Inventors: Mark W. Grenfell, Woodbury, MN (US); Richard M. Minday, Stillwater, MN (US)

Correspondence Address: Attention: Robert H. Jordan, Office of Intellectual Property Counsel, 3M Innovative Properties Company, P.O. Box 33427, St. Paul, MN, 55133-3427, US

(73) Assignee: 3M Innovative Properties Company

(21) Appl. No.: 09/881,416

(22) Filed: Jun. 14, 2001

(51) Int. Cl. G01N 25/00; G01M 3/04

(52) U.S. Cl. 374/57; 73/40.7

(57) ABSTRACT

The present invention provides a method for testing an electronic component comprising exposing the electronic component to a test fluid comprising a fluoroketone that is essentially non-flammable. Preferably the test fluid is comprised of 90% by weight to 100% by weight of the fluoroketone.

Examples of test methods of electronic components in which the fluoroketones can be used include the testing for the hermeticity of a sealed cavity, a liquid burn-in test, a thermal shock test, and an Environmental Stress Screening test (ESS).

### FIELD OF THE INVENTION

The present invention relates to the testing of electronic components using fluorinated ketone test fluids.

### BACKGROUND OF THE INVENTION

Electronic components are subjected to various tests depending on their intended application to assure their performance. For example, microelectronics, semiconductor and other components are often sealed in a cavity within a protective packaging material, with lead wires extending from the circuitry to the exterior of the protective package for connection to other components. The protective package is intended to hold the circuitry in place and protect it against corrosion, oxidation, shock, handling, temperature and other problems that can result in failure. To ascertain reliable operation of such sealed electronic packages, testing their hermeticity is required. Further, electronic components are often subjected to thermal shock testing, Environmental Stress Screening (ESS) and liquid burn-in test to simulate real operating conditions and to warrant their performance under such conditions.

The aforementioned tests typically involve the use of an inert test fluid. As inert test fluid there have been used various fluorinated carbon compounds, including perfluorinated carbon compounds. For example, U.S. Pat. No. 4,920,785 (Etess) discloses the use of FLUORINERT™ Electronic Liquids of the 3M Company such as FC-40, FC-72 and FC-84 in the testing of the hermeticity of an electronic package. U.S. Pat. No. 4,955,726 (Bargigia et al.) discloses the use of perfluoropolyethers as test fluids in thermal shock tests, liquid burn-in tests and tests for the hermeticity of an electronic package.

U.S. Pat. No. 4,736,621 (Slinn et al.) discloses the use of fluoroperhydrofluorene as an inert liquid in testing the hermeticity of an electronic package. U.S. Pat. No. 4,896,529 (Tonelli et al.) discloses the use of perfluoro-2,3,4-trimethylpentane as an indicator fluid in a gross leak test. U.S. Pat. No. 5,369,983 (Grenfell) further discloses a test medium that allows for the simultaneous testing of gross and fine leaks in a sealed electronic package. The medium comprises a perfluorinated compound.

The Environmental Stress Screening (“ESS”) test is described in U.S. Pat. No. 5,187,432 (Bauerfeind et al.). This test was developed to reduce the time needed to perform the burn-in test. By this method, a device is cycled between a cold bath of an inert liquid and a hot bath of inert liquid while a bias voltage is applied for short periods, which voltage exceeds the nominal voltage of the device. The cold bath is maintained at a maximum temperature of 0° C. while the hot bath is maintained at a minimum temperature of 65° C.

Each of these tests uses perfluorocarbon fluids as the test media. The perfluorocarbon fluids have been found to be useful due to their physical properties which include the boiling and freezing points, density, dielectric strength, surface tension, chemical and thermal stability and appearance. In the environmental testing of electronic devices, any or all of these physical properties may be important. The MIW-STD-883E mandates the use of perfluorocarbons in the testing of electronic components.

Since the perfluorocarbons contain no chlorine, they do not damage the Earth's ozone layer, and are not being phased out under the Montreal Protocol. However, due to their chemical stability and long atmospheric lifetime, they have been implicated as having high Global Warming Potentials (GWP) and their use is being increasingly restricted.

World Published Patent Application WO 99/19707 describes the testing of electronic components using a hydrofluoroether test fluid. Hydrofluoroether fluids offer many of the advantages of perfluorocarbon fluids, e.g., they are nonflammable, low in toxicity, and have no ozone depletion potential (ODP), and offer the additional advantage of having low global warming potentials (GWP). However, being somewhat more polar than the perfluorocarbon fluids, the hydrofluoroether fluids can cause swelling of electrical component parts constructed from organic materials, such as circuit boards and wire coatings.

Thus, there remains a need for new test fluids for environmental testing of electronic components that are nonflammable, are low in toxicity, have no ODP, exhibit a low GWP, and, most important, demonstrate the performance requirements needed for the testing of electronic components. These performance requirements are related to desirable physical properties of the fluid such as low surface tension, high density and low viscosity (e.g., for gross leak testing), and thermal stability, high dielectric strength and large liquid range temperature (e.g., for thermal shock testing). These performance requirements are also related to desirable chemical properties of the fluid, especially inertness to the variety of organic materials typically found in electronic components.

### SUMMARY OF THE INVENTION

The present invention provides a method for testing an electronic component by exposing the electronic component to a test fluid characterized in that said test fluid contains a fluorinated ketone that is essentially non-flammable. Preferably the test fluid contains from about 90% by weight to about 100% by weight of a fluorinated ketone.

The fluorinated ketone contains from 5 to 1 8 carbon atoms. The fluorinated ketone can be a perfluoroketone, a compound in which all of the hydrogen atoms on the carbon backbone are replaced with fluorine. Alternatively, the fluorinated ketone can have up to two hydrogen atoms and up to two non-fluorine halogen atoms including bromine, chlorine, and iodine attached to the carbon backbone. One or more heteroatoms can interrupt the carbon backbone of the fluorinated ketone. Additionally, one or more ketone groups can be present (e.g., a diketone).

The test fluid can also include a minor amount of an auxiliary fluorinated compound that is miscible with the fluorinated ketone. Preferably, the test fluid is comprised of 90-100% by weight of the fluorinated ketone.

### DETAILED DESCRIPTION OF ILLUSTRATIVE EMBODIMENTS OF THE INVENTION

It has been found that fluorinated ketones are suitable test fluids for use in a variety of testing methods typically used to test the performance of an electronic component such as electronic circuit boards or electronic packages. The fluorinated ketones for use in the method of the invention are essentially non-flammable. Typically the fluorinated ketones do not exhibit a flash point when tested in a closed cup flash point test performed according to ASTM D 56-87. Preferably, the fluorinated ketone is a perfluoroketone.

The fluorinated ketones of the invention typically have a total of about 5 to about 18 carbon atoms and preferably have a total of 6 to 15 carbon atoms. The fluorinated ketones typically are liquids at room temperature with boiling points up to about 250° C. The fluorinated ketone can be a perfluoroketone, a compound in which all of the hydrogen atoms on the carbon backbone are replaced with fluorine. Alternatively, the fluorinated ketone can have up to two hydrogen atoms and up to two non-fluorine halogen atoms including bromine, chlorine, and iodine attached to the carbon backbone. Perfluoroketones (i.e., ketones where all of the available non-carbonyl valence sites on the carbon atoms have been replaced with fluorine atoms) are preferred because of their very low polarities, making them especially inert toward the variety of organic materials typically encountered in electronic components.

Representative examples of useful perfluoroketones include CF₃(CF₂)₅C(O)CF₃, CF₃C(O)CF(CF₃)₂, CF₃CF₂C(O)CF₂CF₂CF₃, CF₃CF₂CF₂C(O)CF₂CF₂CF₃, CF₃CF₂C(O)CF(CF₃)₂, (CF₃)₂CFC(O)CF(CF₃)₂, (CF₃)₂CFCF₂C(O)CF(CF ₃, (CF₃)₂CF(CF₂)₂C(O)CF (CF₃ )₂, (CF₃ )₂CF(CF₂)₃C (O)CF(CF₃ ) ₂, CF₃(CF₂)₂C(O)CF(CF₃)₂, CF₃(CF₂)₃C(O)CF(CF₃)₂, CF₃(CF₂)₄C(O) CF(CF₃)₂, CF₃( CF₂) ₅C(O)CF(CF₃)₂, (CF₃)₂CFC(O)C(O)CF(CF₃)₂, (CF₃)₂CFC(O)(CF₂)₃C(O)CF(CF₃)₂, C₇F₁₅C(O)CF(CF₃)₂, C₉F₁₉C(O)CF(CF₃)₂, perfluorocyclopentanone, and perfluorocyclohexanone.

Representative examples of useful fluorinated ketones with either one or two atoms other than fluorine attached to the carbon backbone include CHF₂CF₂C(O)CF(CF₃)₂, CF₃C(O)CH₂C(O)CF₃, (CF₃)₂CFC(O)CF₂Cl, CF₂ClCF₂C(O)CF(CF₃)₂, CF₂Cl(CF₂)₂C(O)CF(CF₃)₂, CF₂Cl(CF₂)₃C(O)CF(CF₃)₂, CF₂Cl(CF₂)₄C(O)CF(CF₃)₂, CF₂Cl(CF₂)₅C(O)CF(CF₃)₂, and CF₂ClCF₂C(O)CF₂CF₂CF₃.

The fluorinated ketones can also contain one or more heteroatoms interrupting the carbon backbone. Suitable heteroatoms include, for example, nitrogen, oxygen, and sulfur atoms. Representative examples of such fluorinated ketones include CF₃OCF₂CF₂C(O)CF(CF₃)₂ and CF₃OCF₂C(O)CF(CF₃)₂.

Fluorinated ketones can be prepared by known methods. One approach involves the dissociation of perfluorinated carboxylic acid esters of the formula R_{f}CO₂CF(R_{f}′)₂ with a nucleophilic initiating agent as described in U.S. Pat. No. 5,466,877 (Moore), wherein R_{f} and R_{f}′ are fluorine atoms or a perfluoroalkyl group. The fluorinated carboxylic acid ester precursor can be derived from the corresponding fluorine-free or partially fluorinated hydrocarbon ester by direct fluorination with fluorine gas as described in U.S. Pat. No. 5,399,718 (Costello et al.).

Perfluorinated ketones can be also be prepared by dissociation of perfluorinated carboxylic acid esters (which can be prepared from the corresponding hydrocarbon or partially-fluorinated carboxylic acid esters by direct fluorination with fluorine gas). Dissociation can be achieved by contacting the perfluorinated ester with a source of fluoride ion under reacting conditions (see the method described in U.S. Pat. No. 3,900,372 (Childs)) or by combining the ester with at least one initiating reagent selected from the group consisting of gaseous, non-hydroxylic nucleophiles; liquid, non-hydroxylic nucleophiles; and mixtures of at least one non-hydroxylic nucleophile (gaseous, liquid, or solid) and at least one solvent which is inert to acylating agents.

Perfluorinated ketones that are alpha-branched to the carbonyl group can be prepared as described in, for example, U.S. Pat. No. 3,185,734 (Fawcett et al.) and J. Am. Chem. Soc., v. 84, pp.4285-88, 1962. These branched fluorinated ketones are most conveniently prepared by hexafluoropropylene addition to acyl halides in an anhydrous environment (e.g., in an anhydrous aprotic solvent such as diglyme) in the presence of fluoride ion at an elevated temperature, typically at around 50 to 80° C. The diglyme/fluoride ion mixture can be recycled for subsequent fluorinated ketone preparations, e.g., to minimize exposure to moisture. When this reaction scheme is employed, a small amount of hexafluoropropylene dimer and/or trimer may reside as a by-product in the branched perfluoroketone product. The amount of dimer and/or trimer may be minimized by gradual addition of hexafluoropropylene to the acyl halide over an extended time period, e.g., several hours. These dimer and/or trimer impurities can usually be removed by distillation from the perfluoroketone. In cases where the boiling points are too close for fractional distillation, the dimer and/or trimer impurity may be conveniently removed in an oxidative fashion by treating the reaction product with a mixture of an alkali metal permanganate in a suitable organic solvent such as acetone, acetic acid, or a mixture thereof at ambient or elevated temperatures, preferably in a sealed vessel.

The fluorinated ketone in the test fluid is preferably used alone or in combination with another fluorinated ketone but can also be used in combination with a minor amount, e.g. up to about 10 wt-%, of one or more auxiliary fluorinated compounds that are miscible with the fluorinated ketone. Useful auxiliary fluorinated compounds include hydrofluoroethers, hydrofluorocarbons, perfluorocarbons and perfluoropolyethers.

Representative hydrofluoroethers include segregated hydrofluoroethers of the general formula R_{f}ORₕ)ₙ, wherein R_{f} is a perfluorinated alkyl group preferably containing between 2 and 8 carbon atoms, Rₕ is an alkyl group preferably containing 1 or 2 carbon atoms; n is a number from 1 to 3, and wherein the number of carbon atoms contained in R_{f} is greater than the number of carbon atoms contained in all Rₕ groups (available as NOVEC™ HFE specialty liquids from 3M Company, St. Paul, Minn.).

Representative hydrofluoroethers also include non-segregated hydrofluoroethers such as α,ω-dihydroperfluoropolyethers such as those having the formula HCF₂O(CF₂O)ₙ(CF₂CF₂O)ₘCF₂H, where n is from 0 to 2, m is from 0 to 5, and the sum of n plus m is at least 1 (available as H-GALDEN™ fluids from Ausimont SpA, Milan, Italy).

Representative hydrofluorocarbons include C₅F₁₁H, C₆F₁₃H, CF₃CH₂CF₂CH₃ (HFC-365) and CF₃CFHCFHCF₂CF₃ (HFC-4310, available as VERTREL™ XF fluid from E. I. du Pont de Nemours & Co., Wilmington, Del.).

Representative perfluorocarbons include C₆F₁₄, C₇F₁₆, C₈F₁₈, (C₄F₉)₃N, perfluoro-2-butyltetrahydrofuran and perfluoro-N-methylmorpholine. Such fluids are available as FLUORINER™ specialty liquids from 3M Company.

Representative perfluoropolyethers are described in U.S. Pat. No. 3,250,807 (Fritz et al.), U.S. Pat. No. 3,250,808 (Moore et al.), and U.S. Pat. No. 3,274,239 (Selman), all of which are herein incorporated by reference. Commercially available perfluoropolyethers include KRYTOX™ K fluorinated oils (available from E. I. du Pont de Nemours & Co.), FLUTEC™ PP inert fluorocarbon fluids (available from ISC Chemicals Ltd., Bristol, England) and GALDEN™ HT fluids (available from Ausimont Corp., Thorofare, N.J.).

For environmental reasons, the auxiliary fluorinated compound is preferably a segregated hydrofluoroether such as C₄F₉OCH₃, C₄F₉OC₂H₅, C₃F₇CF (OC₂H₅)CF(CF₃)₂, and the like.

Examples of test methods for electronic components in which a fluorinated ketone can be used include the testing for the hermeticity of a sealed cavity, a liquid burn-in test, a thermal shock test, and an Environmental Stress Screening test (ESS). For safety reasons, the fluorinated ketones used in the test fluids are chosen so that they are nonflammable. An accurate and reliable method for measuring flammability is the closed cup flash point test described in ASTM D 56-87.

The selection of a particular test fluid is dependent on the test method used. Generally the test liquid is chosen such that the boiling point and freezing points provide a sufficient liquid range to conduct the test. In addition, the fluorinated ketone should typically exhibit thermal and chemical stability to the test conditions. Other physical properties such as dielectric strength, density, and surface tension may be considered for use in some environmental tests. For example, the density of the test fluid is preferably considered in the selection of a fluorinated ketone as test fluid in hermeticity testing by the weight gain test. The surface tension is preferably considered in the selection of a fluorinated ketone as a test fluid in leak testing, especially in situations where test fluids must penetrate a small leak. In tests where a bias voltage is applied to an electronic device, the dielectric strength is preferably considered in the selection of a fluorinated ketone as a test fluid. The surface tension of the fluorinated ketone is typically below 14 dynes/cm, the density is typically in the range of 1.5-1.8 gm/mL and the dielectric strength typically in excess of 9000 V/mm.

Hermetic seals are used in a wide variety of applications. For example, in the electronics industry, solid state devices must be protected from the ambient atmosphere to guarantee their continued operation. Ambient air containing moisture can accumulate in the device causing corrosion and failure. High reliability devices are often protected by enclosing the devices in ceramic packages which are hermetically sealed. However, it is not possible to obtain a zero leak rate for every package. The packages must be tested to determine if the leak rate is below a set standard for a given internal sealed volume.

The most common standard employed for ceramic packages is provided in Military Standard (“MIL-STD”) 883E, Method 1014.9. Standard leak rates are based on the leak rate of dry air at 25° C. flowing through a leak path with a high pressure side of the leak at 1 atmosphere (760 torr absolute) and a low pressure side of the leak at less than 1 torr absolute.

In a gross leak test, leak rates between 1×10⁰ atm-cc/sec and 1×10⁻⁵ atm-cc/sec of dry air are tested. In accordance with the present invention, a fluorinated ketone can be used as a test fluid to penetrate the gross leak openings due to its low surface tension. The gross leak test may include a bubble test, a weight gain test, and a test wherein the fluorinated ketone is detected by an analytical technique such as infrared detection. These tests are non-destructive.

Gross leak testing involving the bubble test typically comprises in the order given the steps of (a) placing an electronic package in a test chamber and evacuating to a pressure no greater than 5 torr for about 30 minutes, (b) pressure bombing the electronic package with a detector fluid, (c) removing the electronic package from the chamber and allowing the electronic package to dry, (d) immersing the electronic package in an indicator fluid at a temperature above the boiling point of the detector fluid and (e) observing whether bubbles appear, the bubbles being indicative of leaks. The fluorinated ketone can be used as the detector fluid, the indicator fluid, or both.

A typical embodiment of the bubble test involves placing the electronic package in a “bombing chamber.” The chamber is first evacuated, then the detector fluid is “bombed” into the leaky package under a pressure of up to 90 psia (0.62 MPa) for up to 12.5 hours to force the detector fluid into any leaks in the device. After bombing, the packages are removed and dried.

The packages are then placed into a bubble tank for leak detection. The bubble tank contains an indicator fluid. The indicator fluid is typically heated to about 125° C. ±5° C. The packages are immersed into the indicator fluid to a minimum depth of about two inches. If there is a leak in the package, the detector fluid in the package cavity vaporizes causing bubbles to form. The formation and size of the bubbles are monitored against a lighted, flat black background. If no bubbles form within a 30 second period, the package is considered to have no gross leaks.

The weight gain test is another gross leak test which is commonly used and is described in MIL-STD-883E, Method 1014.9, Test Condition E. The weight gain test detects a leak by measuring the change in weight of a package after the detector fluid has been forced into the package through the leak. The weight gain test comprises the steps of (a) weighing the electronic package, (b) introducing the package to the chamber and evacuating it, (c) pressure bombing the electronic package with detector fluid, (d) removing the electronic package from the chamber and allowing the electronic package to dry, (e) weighing the electronic package, a weight gain of the electronic package being indicative of leaks. In accordance with this invention, a fluorinated ketone can be used as the detector fluid.

In accordance with an embodiment of this method, the electronic packages to be tested are cleaned, dried and weighed. The packages are then grouped into “cells” depending upon their internal volume. Packages with an internal volume of less than 0.01 cc are put into cells of 0.5 milligram increments and packages with an internal volume greater than or equal to 0.01 cc are put into cells in 1 milligram increments.

The packages are typically placed under a 5 torr vacuum for one hour. The fluorinated ketone detector fluid is admitted into the bombing chamber to cover the packages without breaking the vacuum. The packages are pressurized, for example, to 75 psia (0.52MPa) for two hours. For sensitive parts, a lower pressure may be used with a longer bombing cycle. After bombing, the parts are air dried for approximately two minutes.

The packages are weighed individually and categorized. A package is rejected as a leaker if it gains 1.0 milligrams or more. When the packages are categorized, any package which shifts by more than one cell shall be considered a reject. If a package loses weight, it may be retested after baking for eight hours at 125° C.

Another gross leak test that can be employed involves the detection of the detector fluid by an analytical technique such as infrared detection. Thus, this method comprises in the order given the steps of (a) introducing the electronic package to a chamber and evacuating it, (b) pressure bombing the electronic package with a detector fluid attempting thereby to introduce detector fluid into the cavity; (c) removing said electronic package from the chamber to permit a quantity of detector fluid to vaporize and evolve from the cavity as an indication of a leak; and (d) detecting evolving detector vapor by an analytical technique. As detector fluid a fluorinated ketone can be used.

Such a method is described in U.S. Pat. No. 4,920,785 (Etess) and is typically called an NID™ test. The amount of detector fluid (fluorinated ketone) evolving from the package after the bombing step can be measured by measuring the infrared absorption of the atmosphere from the test chamber. The measured amount is proportional to the gross leak size. Other measurement instruments can be used with the NID™ test procedure. These instruments include an ultraviolet spectrometer, a thermal conductivity detector, a photoionization detector and an electron capture detector. The detector system manufactured by Web Technology, Inc. (Dallas, Tex.) employs an infrared absorption detector.

Fluorinated ketones useful in a hermetic seal test (bubble test, weight gain test and NID™ test) as detector fluids are fluorinated ketones having boiling points approximately in the range of 50-100° C. Several examples of such useful ketones are shown in TABLE 1.

TABLE 1

| Fluorinated Ketone | Boiling Point (° C.) |
|---|---|
| CF₃CF₂C(O)CF₂CF₂CF₃ | 52 |
| perfluorocyclohexanone | 53 |
| (CF₃)₂CFC(O)CF₂Cl | 56 |
| HCF₂CF₂C(O)CF(CF₃)₂ | 70-71 |
| CF₃C(O)CH₂C(O)CF₃ | 70-71 |
| (CF₃)₂CFC(O)CF(CF₃)₂ | 71-72 |
| CF₃CF₂CF₂C(O)CF(CF₃)₂ | 73-75 |
| CF₃CF₂CF₂C(O)CF₂CF₂CF₃ | 75 |
| CF₃OCF₂CF₂C(O)CF(CF₃)₂ | 77 |
| CF₃(CF₂)₅C(O)CF₃ | 97 |
| CF₃(CF₂)₃C(O)CF(CF₃)₂ | 97 |
| (CF₃)₂CFC(O)C(O)CF(CF₃)₂ | 98 |

Fluorinated ketones useful in the hermetic seal test as indicator fluids are fluorinated ketones having boiling points of ranging from 120° C. to 210° C. Several examples of such useful ketones are shown in TABLE 2.

TABLE 2

| Fluorinated Ketone | Boiling Point (° C.) |
|---|---|
| C₇F₁₅C(O)CF(CF₃)₂ | 125 |
| (CF₃)₂CFC(O)(CF₂)₃C(O)CF(CF₃)₂ | 148-151 |
| C₉F₁₉C(O)CF(CF₃)₂ | 182-183 |

Fluorinated ketones can also be used as a testing liquid in thermal shock testing of electronic components. Typically, a thermal shock test comprises the steps of subjecting the electronic component in a first liquid at a temperature between −75° C. and 0° C. and subjecting the electronic component in a second liquid at a temperature between 100° C. and 210° C. The electronic components can be cycled between the first and second liquid several times. Subsequently, the physical and electrical characteristics of the electronic component are tested. The modalities of the thermal shock test are described in MIL-STD-883E, Method 1011.9. Fluorinated ketones can be used as the first and/or second liquid depending on its boiling point and freezing point.

For thermal shock testing a device is contacted with a first fluid at a temperature between −75° C. and 0° C., the component is removed from the first fluid and contacted with a second fluid at a temperature between 100° C. and 210° C. A fluorinated ketone may serve as either the low temperature fluid, the high temperature fluid or both. Consequently the fluorinated ketone serving as a low temperature fluid must have a freezing point below 0° C., and preferably below −75° C. The fluorinated ketone serving as a high temperature fluid must have a boiling point about 100° C. (for MIL-STD-883E, Method 1011.9, test A), above 125° C. (Method 1011.9, test B) or above 150° C. (Method 1011.9, test C). Thus a fluorinated ketone that meets both the boiling point and freezing point requirements can be used as both the first and second fluid. Temperature excursions of +10° C. for the hot bathes and of −10° C. for the cold baths are allowed. It is typically required that the transfer of the electronic devices from the one to the other bath and vice-versa takes place within very short times, not longer than 10 seconds. Fluorinated ketones for use as test fluids in thermal shock testing of electronic components also preferably have a thermal conductivity between 0.5 and 0.8 mWatts/cm-° C. and a specific heat between 0.24 and 0.27 calgm-° C.

Fluorinated ketones that can be used as the first test fluid for the cold bath include the following ketones shown in TABLE 3:

TABLE 3

| | Freezing Point |
|---|---|
| Fluorinated Ketone | (° C.) |
| (CF₃)₂CFC(O)CF(CF₃)₂ | −66 to −60 |
| CF₃CF₂CF₂C(O)CF(CF₃)₂ | −74 |
| CF₃CF₂C(O)CF(CF₃)₂ | −108 |

Preferred fluorinated ketones that can be used as the second test fluid for the hot bath include those ketones listed in TABLE 2 that have a boiling point of greater than 125° C.

Fluorinated ketones are also suitable for use as test fluids in Environmental Stress Screening (ESS) tests. Such tests are typically performed to simulate operation of the electronic component over a long period of time, for example, one year.

Typically, the test comprises the steps of,

(a) immersing the electronic component in a cold bath of an inert test fluid;

(b) applying power supply voltages to the electronic component in excess of the maximum operational voltages upon a first predefined period of time elapsing;

(c) removing the power supply voltages from the electronic component;

(d) transferring the electronic component from the cold bath to a hot bath of an inert test fluid within a second predefined period of time;

(e) applying the power supply voltages to the electronic component in excess of the maximum operational voltages as the electronic component is immersed in the hot bath;

(f) removing the power supply voltages from the electronic component; and

(g) repeating steps (a) to (f) for a predefined number of cycles.

The fluorinated ketone can be used in the cold bath and/or the hot bath, depending on the freezing and boiling point of the fluorinated ketone and the actual temperatures used in the cold and hot bath. According to one particular embodiment of this method, the cold bath is used at a temperature below 0° C. and the hot bath is used at a temperature of more than 65° C. According to a further embodiment of this method, the cold bath is used at a temperature of ±20° C. and the hot bath is used at a temperature of more than 85° C. Examples of fluorinated ketones suitable for use in the cold bath of this latter embodiment are CF₃CF₂C(O)CF(CF₃)₂ and (CF₃)₂CFC(O)CF(CF₃)₂, the ketones having freezing points of approximately −108° C. and −63° C., respectively. Examples of fluorinated ketones suitable for use in the hot bath of the latter embodiment include CF₃(CF₂)₅C(O)CF₃ and CF₃(CF₂)₃C(O)CF(CF₃)₂, both ketones having boiling points of approximately 970° C. Fluorinated ketones suitable for use in both the hot and cold baths possess a useful liquid range between −20° C. and 85° C.

The fluorinated ketones are further suitable for use as test fluids in a liquid burn-in test. The liquid burn-in test is performed for the purpose of screening or eliminating marginal devices, those with inherent defects or defects resulting from manufacturing aberrations which cause time and stress dependent failures. It is the intent of this test to stress microcircuits at or above maximum rated operating conditions.

In the liquid burn-in test a microelectronic device is subjected to specific test conditions dependent on the type of device, and its performance and design specifications. The devices are subjected for given time intervals at specified temperatures with a voltage applied to the device or circuit. Generally, the burn-in test is carried out by placing the electronic component to be tested in the fluorinated ketone test fluid at a temperature of 1000° C., powering the electronic component, for example by applying a voltage to the electronic component, and gradually increasing the temperature of the test fluid to a temperature in the range between 125° C. and 250° C. Fluorinated ketones suitable for use in such a burn-in test should have a boiling point above the maximum temperature used in the test. Temperatures for this burn-in test are generally above 125° C., except for large devices known as hybrids or hybrid circuits. Required times at given temperatures are specified by MNL-STD-883E.

When more than one test fluid is employed in any of the above-mentioned electronic component testing procedures, one of the test fluids can be an auxiliary fluorinated compound in place of the fluorinated ketone. Suitable auxiliary fluorinated compounds are the same compounds as previously described in this invention and thus include hydrofluoroethers, hydrofluorocarbons, perfluorocarbons and perfluoropolyethers. For example, in leak detection, the detecting fluid can be a fluorinated ketone, such as CF₃CF₂C(O)CF(CF₃)₂, and the indicating fluid can be an auxiliary fluorinated compound, for example, a perfluorinated tertiary amine such as Fluorinert™ FC-40 electronic liquid.

### EXAMPLES

The following examples further describe the methods of using fluorinated ketones as test fluids in electronic component testing. The examples are provided for exemplary purposes to facilitate the understanding of the invention and should not be construed to limit the invention to the examples. Unless otherwise specified, all percentages and proportions are by weight.

### Test Fluid Sources

CF₃CF₂C(O)CF(CF₃)₂ (1,1,1,2,4,4,5,5,5-nonafluoro-2-trifluoromethyl-pentan-3-one)—Into a clean dry 600 mL Parr reactor equipped with stirrer, heater and thermocouple were added 5.6 g (0.10 mol) of anhydrous potassium fluoride (available from Sigma Aldrich Chemical Co., Milwaukee, Wis.) and 250 g of anhydrous diglyme (anhydrous diethylene glycol dimethyl ether, available from Sigma Aldrich Chemical Co., Milwaukee, Wis.). The anhydrous potassium fluoride used in this synthesis, and in all subsequent syntheses, was spray dried, stored at 125° C. and ground shortly before use. The contents of the reactor were stirred while 21.0 g (0.13 mol) of C₂F₅COF (approximately 95.0 percent purity available from 3M Company, St. Paul, Minn.) was added to the sealed reactor. The reactor and its contents were then heated, and when a temperature of 70° C. had been reached, a mixture of 147.3 g (0.98 mol) of CF₂=CFCF₃ (hexafluoropropylene, available from Sigma Aldrich Chemical Co.) and 163.3 g (0.98 mol) of C₂F₅COF was added over a 3.0 hour time period. During the addition of the hexafluoropropylene and the C₂F₅COF mixture, the pressure was maintained at less than 95 psig (7500 torr). The pressure at the end of the hexafluoropropylene addition was 30 psig (2300 torr) and did not change over the 45-minute hold period. The reactor contents were allowed to cool and were one-plate distilled to obtain 307.1 g containing 90.6% 1,1,1,2,4,4,5,5,5-nonafluoro-2-trifluoromethyl-butan-3-one and 0.37% C₆F₁₂ (hexafluoropropylene dimer) as determined by gas chromatography. The crude fluorinated ketone was water-washed, distilled, and dried by contacting with silica gel to provide a fractionated fluorinated ketone of 99% purity and containing 0.4% hexafluoropropylene dimers.

A fractionated fluorinated ketone made as described above was purified of hexafluoropropylene dimers using the following procedure. Into a clean dry 600 mL Parr reactor equipped with stirrer, heater and thermocouple were added 61 g of acetic acid, 1.7 g of potassium permanganate, and 301 g of the above-described fractionated 1,1,1,2,4,4,5,5,5-nonafluoro-2-trifluoromethyl-butan-3-one. The reactor was sealed and heated to 60° C., while stirring, reaching a pressure of 12 psig (1400 torr). After 75 minutes of stirring at 60° C., a liquid sample was taken using a dip tube, the sample was phase split and the lower phase was washed with water. The sample was analyzed using glc and showed undetectable amounts of hexafluoropropylene dimers and small amounts of hexafluoropropylene trimers. A second sample was taken 60 minutes later and was treated similarly. The glc analysis of the second sample showed no detectable dimers or trimers. The reaction was stopped after 3.5 hours, and the purified ketone was phase split from the acetic acid and the lower phase was washed twice with water. 261 g of the ketone was collected, having a purity greater than 99.6% by glc and containing no detectable hexafluoropropylene dimers or trimers.

(CF₃)₂CFC(O)CF(CF₃)₂ (1,1,1,2,4,5,5,5,6,6,6-octafluoro-2,4-bis(trifluoromethyl)pentan-3-one)—8.1 g (0.14 mol) of anhydrous potassium fluoride, 216 g (0.50 mol) of perfluoro(isobutyl isobutyrate) (made by reacting isobutyl isobutyrate with fluorine gas as described in U.S. Pat. No. 5,399,718 (Costello et al.)) and 200 grams of anhydrous diglyme were charged to a clean dry 600 mL Parr pressure reactor. After cooling the reactor to <0° C., 165 g (1.10 mol) of hexafluoropropylene was added to the resulting mixture. The contents in the reactor were allowed to react overnight at 70° C. with stirring, then the reactor was allowed to cool and the excess pressure in the reactor was vented to the atmosphere. The contents of the reactor were then phase split to obtain 362.5 g of lower phase. The lower phase was retained and mixed with lower phases saved from previous analogous reactions. To 604 g of accumulated lower phases containing 22% perfluoroisobutyryl fluoride and 197 g (1.31 mol) of hexafluoropropylene was added 8 g (0.1 mol) of anhydrous potassium fluoride and 50 g of anhydrous diglyme, and the resulting mixture was allowed to react in the Parr reactor in the same manner as before. This time 847 g of lower phase resulted, containing 54.4% of desired material and only 5.7% of perfluoroisobutyryl fluoride. The lower phase was then water washed, dried with anhydrous magnesium sulfate, and fractionally distilled to give 359 g of 1,1,1,2,4,5,5,5,6,6,6-octafluoro-2,4-bis(trifluoromethyl)pentan-3-one having 95.2% purity as determined by gas chromatography and mass spectroscopy (“gcms”) (47% theoretical yield) and having a boiling point of 73° C.

FC-40—Fluorinert™ FC-40 electronic liquid, a perfluorocarbon having a boiling point of 155° C., available from 3M Company, St. Paul, Minn.

FC-6001—Fluorinert™ FC-6001 thermal shock testing liquid, a perfluorocarbon, available from 3M Company.

FC-6003—Fluorinert™ FC-6003 thermal shock testing liquid, a perfluorocarbon, available from 3M Company.

FC-72—Fluorinert™ FC-72 electronic liquid, C₆F₁₄, a perfluorocarbon having a boiling point of 56° C., available from 3M Company.

### Example 1

To determine the efficacy of CF₃CF₂C(O)CF(CF₃)₂ (a perfluoroketone) as a hermetic seal leak detector fluid, standard ceramic dual in-line packages (C-Dips) obtained from Texas Instruments, Inc. (Dallas, Tex.) were tested using the parameters required by Mil Spec 883. Of these packages, three were known gross leakers and two were known non-leakers, as identified from actual production leak testing. All packages were evacuated for 30 minutes, covered with CF₃CF₂C(O)CF(CF₃)₂ as the detector fluid, and pressurized for 60 minutes at 90 psig (4650 torr). After the packages were removed from the detector fluid and air dried for 3 minutes, they were immersed in FC-40 indicator fluid kept at 125 ° C. All three known gross leakers evolved large amounts of CF₃CF₂C(O)CF(CF₃)₂ bubbles and stopped bubbling within 30 seconds, indicating their cavities had become completely emptied of detector fluid. The two known non-leaking packages did not exhibit any bubbling when immersed in the FC-40 indicator fluid, indicating the absence of perfluoroketone detector fluid in the non-leaking packages.

### Example 2

Essentially the same leak testing procedure was followed as described in Example 1, except that (CF₃)₂CFC(O)CF(CF₃)₂ (a higher boiling perfluoroketone) was substituted for CF₃CF₂C(O)CF(CF₃)₂ as a detector fluid. Again, the known leaking packages evolved large quantities of perfluoroketone bubbles when placed in the FC-40 indicator fluid, with bubbling ceasing within 30 seconds, indicating total evacuation of the detector fluid. The non-leaking packages did not bubble when placed in the FC-40 indicator fluid.

### Example 3

This example concerns the suitability of perfluoroketones such as CF₃CF₂C(O)CF(CF₃)₂ for use as test fluids in burn-in testing and Environmental Stress Screening (ESS) testing of electronic components.

Liquid burn-in testing and ESS testing can employ PFKs in place of PFCs as test fluids due to the similarity of their thermal and electrical properties. The temperature requirements of ESS are less severe than with thermal shock testing. U.S. Pat. No. 5,187,432 (AT&T's patent entitled “Environmental Stress Screening Process”) recites a cold side temperature of less than 0° C. and a hot side temperature of greater than 65° C. Therefore, CF₃CF₂C(O)CF(CF₃)₂ can function very well as a cold side fluid and CF₃(CF₂)₅C(O)CF₃ can function well as a hot side fluid.

Liquid burn-in temperature fluid requirements begin at 100° C. and progress to 250° C. The temperatures move in five ° C. gradations from 100° C. to 150° C. and in 25° C. gradations from 150° C. to 250° C. Fluorinated ketone fluids suitable for certain of these temperature ranges can be selected from the ketones presented in TABLE 2.

We claim:

1. A method for testing an electronic component comprising exposing the electronic component to an inert test fluid characterized in that said test fluid comprises a fluorinated ketone that is essentially non-flammable and has 5 to 18 carbon atoms and up to 2 hydrogen atoms.

2. A method according to claim 1 wherein said method is selected from the group consisting of:
(a) methods of hermetic seal testing for testing the hermeticity of a sealed cavity within an electronic package;
(b) methods of thermal shock testing;
(c) methods of Environmental Stress Screening testing; and
(d) methods of liquid burn-in testing.

3. A method according to claim 2 wherein said method is a hermetic seal test for testing the hermeticity of a sealed cavity within an electronic package.

4. A method according to claim 3 wherein said hermetic seal test is a gross-leak test comprising, in the order given, the steps of:
(a) placing said electronic package in a test chamber and evacuating the chamber to a pressure no greater than 5 torr for about 30 minutes;
(b) pressure bombing the electronic package with a detector fluid;
(c) removing said electronic package from said chamber and allowing the electronic package to dry;
(d) immersing the electronic package in an indicator fluid at a temperature above the boiling point of said detector fluid; and
(e) observing whether bubbles appear, said bubbles being indicative of leaks and wherein said test fluid is said detector fluid or said indicator fluid.

5. A method according to claim 3 wherein said hermetic seal test is a gross-leak test comprising, in the order given, the steps of:
(a) weighing said electronic package;
(b) introducing said electronic package to a chamber and evacuating to a pressure no greater than 5 torr for about 30 minutes;
(c) pressure bombing the electronic package with a detector fluid;
(d) removing said electronic package from said chamber and allowing the electronic package to dry;
(e) weighing said electronic package, a weight gain of said electronic package being indicative of leaks; and wherein said test fluid is said detector fluid.

6. A method according to claim 3 wherein said hermetic seal test is a gross-leak test comprising, in the order given, the steps of:
(a) introducing said electronic package to a chamber and evacuating to a pressure no greater than 5 torr for about 30 minutes;
(b) pressure bombing the electronic package with a detector fluid attempting thereby to introduce detector fluid into the cavity;
(c) removing said electronic package from said chamber to permit a quantity of detector fluid to vaporize and evolve from said cavity as an indication of a leak; and
(d) detecting evolving detector vapor by an analytical technique.

7. A method according to claim 1 wherein said method is a thermal shock test.

8. A method according to claim 7 wherein said thermal shock test comprises the steps of subjecting said electronic component in a first liquid at a temperature between −75° C. and 0° C. and subjecting said electronic component in a second liquid at a temperature between 100° C. and 210° C. and wherein said test fluid is said first liquid and/or said second liquid.

9. A method according to claim 2 wherein said method is an Environmental Stress Screening test.

10. A method according to claim 9 wherein said Environmental Stress Screening test comprises the steps of:
(a) immersing said electronic component in a cold bath of an inert test fluid;
(b) applying power supply voltages to the electronic component in excess of the maximum operational voltages upon a first predefined period of time elapsing;
(c) removing the power supply voltages from the electronic component;
(d) transferring the electronic component from the cold bath to a hot bath of an inert liquid within a second predefined period of time;
(e) applying the power supply voltages to the electronic component in excess of the maximum operational voltages as the electronic component is immersed in the hot bath;
(f) removing the power supply voltages from the electronic component; and
(g) repeating steps (a) to (f) for a predefined number of cycles; and wherein said test fluid is said inert liquid of said cold bath and/or said inert liquid of said hot bath.

11. A method according to claim 10 wherein said cold bath is maintained at a temperature of less than 0° C. and said hot bath at a temperature of more than 65° C.

12. A method according to claim 2 wherein said method is a liquid burn-in test.

13. A method according to claim 12 wherein said liquid burn-in test comprises the steps of placing said electronic component in said test fluid at 100° C., applying a voltage thereto and gradually increasing the temperature of said test fluid to a temperature between 125° C. and 250° C.

14. The method of claim 1, wherein the fluorinated ketone further has up to two halogen atoms selected from the group consisting of chlorine, bromine, iodine, and a mixture thereof.

15. The method of claim 1, wherein the fluorinated ketone further contains one or more heteroatoms interrupting the carbon atoms, said heteroatoms selected from the group consisting of oxygen, nitrogen, and sulfur.

16. The method of claim 1, wherein the fluorinated ketone is a perfluoroketone.

17. The method of claim 16, wherein the perfluoroketone is selected from the group consisting of CF₃(CF₂)₅C(O)CF₃, CF₃C(O)CF(CF₃)₂, CF₃CF₂C(O)CF₂CF₂CF₃, CF₃CF₂CF₂C(O)CF₂CF₂CF₃, CF₃CF₂C(O)CF(CF₃)₂, (CF₃)₂CFC(O) CF(CF₃)₂, (CF₃)₂CFCF₂C(O)CF(CF₃)₂, (CF₃)₂CF(CF₂)₂C(O)CF(CF₃)₂, (CF₃)₂CF(CF₂)₃C(O)CF(CF₃)₂, CF₃(CF₂)₂C(O)CF(CF₃)₂, CF₃(CF₂)₃C(O)CF(CF₃)₂, CF₃(CF₂)₄C(O)CF(CF₃)₂, CF₃(CF₂)₅C(O)CF(CF₃)₂, (CF₃)₂CFC(O)C (O)CF(CF₃)₂, (CF₃)₂CFC(O)(CF₂)₃C(O)CF(CF₃)₂, C₇F₁₅C(O)CF(CF₃)₂, C₉F₁₉C(O)CF(CF₃)₂, perfluorocyclopentanone, and perfluorocyclohexanone, and mixtures thereof.

18. The method of claim 1, where the fluorinated ketone is CHF₂CF₂C(O)CF(CF₃)₂ or CF₃C(O)CH₂C(O)CF₃.

19. The method of claim 14, where the fluorinated ketone is (CF₃)₂CF(CO)CF₂Cl.

20. The method of claim 15, where the fluorinated ketone is CF₃OCF₂CF₂C(O)CF(CF₃)₂.

21. The method of claim 1, wherein said test fluid further comprises up to about 10 wt-% of a hydrofluoroether, a hydrofluorocarbon, a perfluorocarbon, a perfluoroether or a mixture thereof that is nonflammable.
